(19) United States
(12) Patent Application Publication
(10) Pub. No.: US 2001/0049279 A1
(43) Pub. Date: Dec. 6, 2001

(54) Method of optimizing the storage of information in a mobile radiocommunications terminal and a terminal for implementing the method

(75) Inventors: Eric Vermelle, Colombes (FR); Pascal Hubbe, Paris (FR); Franck Barbet, La Ciotat (FR)

Correspondence Address: SUGHRUE, MION, ZINN, MACPEAK & SEAS, PLLC, 2100 Pennsylvania Avenue, NW, Washington, DC, 20037-3213, US

(73) Assignee: ALCATEL

(21) Appl. No.: 09/853,675

(22) Filed: May 14, 2001

(30) Foreign Application Priority Data
May 15, 2000 (FR) 00 06 169

(51) Int. Cl. H04M 3/00

(52) U.S. Cl. 455/419; 455/466

(57) ABSTRACT

A method of optimizing an external and/or internal memory of a radiocommunications terminal in which information received by said terminal is stored and permanently associated with an indicator representative of the erasable nature of said information, wherein erasable information is erased automatically as a function of the consulting of said information by the user.

The present invention relates to a method of optimizing the storage of information in a radiocommunications terminal. The invention also relates to a radiocommunications terminal implementing the method.

### BACKGROUND OF THE INVENTION

A non-exclusive field of application of the invention is that of mobile telephones operating in radiocommunications networks. These devices have a limited capacity for storing received information. At present, only around twenty items of received information can be stored in an external memory such as a Subscriber Identity Module (SIM) card. This limitation can result from the overall size of the device, given the resources needed to store more than about twenty items of information. An object of the invention is to optimize the storage of information in the external memory of the mobile telephone in order to limit saturation and without necessitating intervention by the user. The invention is not limited to optimizing an external memory, and applies equally to optimizing an internal memory of a mobile telephone.

In the Global System for Mobile communications (GSM), the information referred to consists of Short Message Service (SMS) text messages. Using the alphanumeric keypad of the mobile telephone, the telephone user enters an SMS message which is sent to the user of another mobile telephone via the GSM's Short Message Service Center (SMSC). The user can equally receive general interest messages transmitted directly by the network. A Data Coding Scheme (DCS) byte is associated with the SMS message by the sending mobile telephone or directly by the SMSC. The DCS byte includes several bits indicating, among other things, the coding of the data of the SMS message, the sender and the addressee. Given these indications, the receiving mobile telephone knows how to interpret the message received and display it on its display screen. The SMS specifications are set out in ETSI/TL GSM Recommendation 03.40, according to which an SMS message can contain a maximum of 160 characters. Provided that the telephone is logged onto its radiocommunications network, an SMS message is received by the mobile telephone without action by the user. If the terminal is not logged on, then the SMS message is stored in the SMSC and the telephone's Home Location Register (HLR) is advised of the presence of the waiting SMS message in the SMSC. When the user requests to log on, the HLR is advised of the request to log on via the nearest base transceiver station, makes the connection and sends a signal to the SMSC. The SMSC then sends the SMS message to the mobile telephone. The SMS message is then stored in the mobile telephone until the telephone user consults it.

In the prior art, and in particular in the document WO 95/06996, after the user consults the SMS message, he has a choice of retaining the SMS message in the external memory in the SIM card of the mobile telephone, retaining the message in the internal memory of the mobile telephone, or erasing the message to free up memory space. The technique disclosed in the above document has the drawback that management of the memory capacity of the telephone is left to the user. If the user forgets to erase less important messages regularly, or to transfer them from one memory to the other, then the saturated external memory is no longer able to accept a new message.

In the prior art, and in particular in the document EP 0 858 238 A2, when an SMS message received by the mobile telephone is stored, several bytes are associated with the SMS message, and in particular a Status byte. The Status byte is associated with the SMS message by copying only the data of the DCS byte needed for the SIM card to manage the SMS message. The STATUS byte indicates, among other things, the identity of the sender of the SMS message and whether the message is a “Replace” message or not. If the incoming message is a Replace message, and if a Replace message sent by the same sender has already been stored in the SIM card, then the new message is stored in place of the old one. Otherwise, the message is stored in one of the empty memory spaces in the SIM card and is processed in the manner described in the previous paragraph. However, this solution has two major drawbacks. First of all, if the telephone user does not have time to consult a Replace message that has been stored before another Replace message sent by the same sender arrives, then the new message is stored in place of the previous one, without the user becoming aware of the content of the first message. Secondly, if the telephone user forgets to erase the less important messages, then the memory of the SIM card becomes saturated and can receive only Replace messages sent by a sender who has already sent a Replace message.

### OBJECTS AND SUMMARY OF THE INVENTION

An object of the invention is to alleviate these drawbacks and in particular to improve the management of SMS messages in an external and/or internal memory of a terminal without intervention by the user and without automatically deleting messages that have not been consulted.

To this end, the invention proposes a method of optimizing an external and/or internal memory of a radio-communications terminal in which information received by said terminal is stored and permanently associated with an indicator representative of the erasable nature of said information, wherein erasable information is erased automatically as a function of the consulting of said information by the user.

In particular, in the method, the information is SMS information.

If the information is sent by a user of another terminal, the step of permanently associating a status indicator representative of said information is executed by said user to force the automatic erasing of the information stored in the memory of the receiving terminal after it has been consulted by the user of the receiving terminal.

If the information is sent by an operator of a radiocommunications network, the step of permanently associating a status indicator representative of said information is executed by the operator to force the automatic erasing of the information stored in the memory of the terminal after it has been consulted by the user of the terminal.

If the radiocommunications terminal includes an internal memory and an external memory, if the external memory is full, non-erasable information that has not been consulted is transferred automatically into the internal memory.

If the radiocommunications terminal includes an internal memory and an external memory, if information is received when the external memory is full, non-erasable information that has not been consulted is transferred automatically into the internal memory.

If the radiocommunications terminal includes an internal memory and an external memory, all non-erasable information is automatically transferred into the internal memory after it has been consulted.

In another aspect the invention provides a radiocommunications terminal for implementing the method previously described, including an external and/or internal memory, the terminal including means for identifying an indicator of the erasable nature of information and means for automatically deleting erasable information received and stored in the memory of the terminal as a function of the consulting of said information by the terminal user.

The radiocommunications terminal advantageously includes external memory in an SIM card.

The radiocommunications terminal preferably includes means for automatically transferring non-erasable information into the internal memory if the external memory is full.

The radiocommunications terminal equally includes means for automatically transferring non-erasable information that has not been consulted into the internal memory if information is received when the external memory is full.

The radiocommunications terminal also includes means for automatically transferring non-erasable information into the internal memory after it has been consulted.

### BRIEF DESCRIPTION OF THE DRAWINGS

Other features emerge from the following detailed description given with reference to the accompanying drawings. The figures are provided exclusively by way of non-limiting examples of the invention. In the FIGS.:

FIG. 1 is a diagram showing a radio-communications terminal including an external memory and an internal memory,

FIG. 2 is a diagram showing a frame containing a DCS header and an item of information transmitted by a radiocommunications network and received by a terminal,

FIG. 3 is a diagram of the steps of one embodiment of the method according to the invention,

FIG. 4 is a diagram of the steps of a first embodiment of a method of managing non-erasable information,

FIG. 5 is a diagram of the steps of a second embodiment of a method of managing non-erasable information, and

FIG. 6 is a diagram of the steps of a third embodiment of a method of managing non-erasable information.

### MORE DETAILED DESCRIPTION

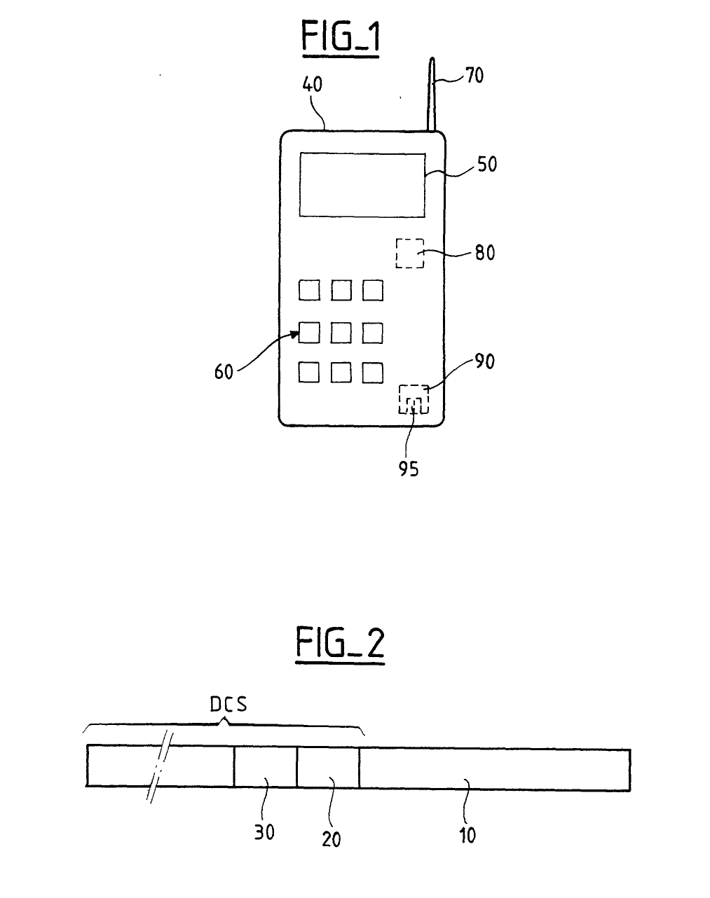

FIG. 1 is a diagram showing a radiocommunications terminal 40 including an external memory and an internal memory.

The expression “radiocommunications terminal” refers primarily to a mobile telephone, but can equally well refer to a pager with the capacity to transmit and receive information, or more generally to any type of terminal for transmitting and receiving information in a radiocommunications network.

The radiocommunications terminal 40 includes a communications interface including a screen 50 and a keypad 60 to enable the user to communicate with the terminal. An antenna 70 transmits or receives information to or from the radiocommunications network. As a result of the execution of a program by a processor (not shown), received information is stored either in an internal memory 80 or in an external memory 95 located in a removable SIM 90 card belonging to the terminal user (the subscriber). The two memories 80 and 90 are connected to a power supply of the terminal (not shown) and are non-volatile memories. Stored information is therefore not destroyed if the power supply is disconnected from the terminal.

FIG. 2 is a diagram showing a frame including a DCS byte forming a header associated with an item of information transmitted by a radiocommunications network and received by a terminal. The DCS byte is associated with the information 10 by the radiocommunications terminal that sent the information 10 or by the radiocommunications network operator, i.e. the agency directly responsible for transmitting the information 10 to its subscribers. The DCS byte includes:

data representing an indicator 20 representative of the erasable nature of the information, if the user of the sending terminal or the operator wishes to include that indicator in the DCS byte, and

data representing the consultation status 30 of the information.

In the GSM, the information 10 can be an SMS message containing 160 characters maximum. The information 10 can equally well be an audio file, a video file or a multimedia file, or more generally any type of information received or transmitted by a radiocommunications terminal.

The GSM is mentioned as one example of application of the present invention. The invention can be applied to other systems of radiocommunications terminals that use removable SIM cards and can receive or transmit information.

It is clear that the expression DCS byte refers to any multiplet or other message associated with the information and including an indicator representative of the erasable nature of the information.

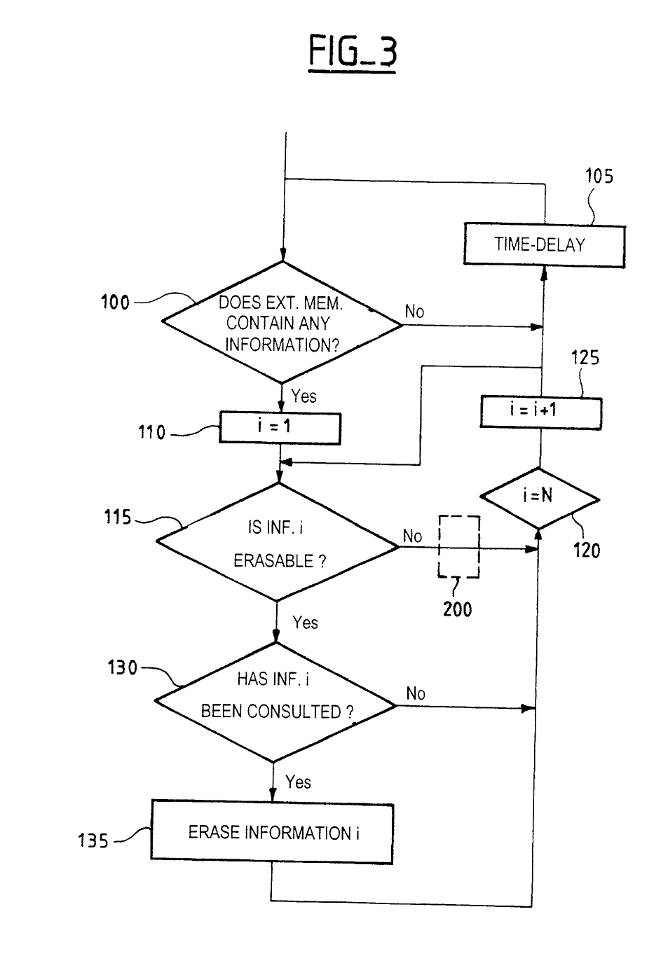

FIG. 3 is a diagram showing steps of one embodiment of a method according to the invention.

The number N of items of information in the external memory is determined in the step 100. The expression “external memory” refers to a memory contained in a removable SIM card.

If N=0, then the next step is the step 105 which applies a time-delay, after which it is determined whether the external memory has received a message in the meantime.

If N≠0, then a counter i is initialized to 1 during the step 110.

Whether the information is erasable is determined in the step 115:

If it is erasable (i.e. if the indicator 20 (FIG. 2) of the DCS byte associated with the current item of information has a value signifying “erasable”), then the next step is the step 130.

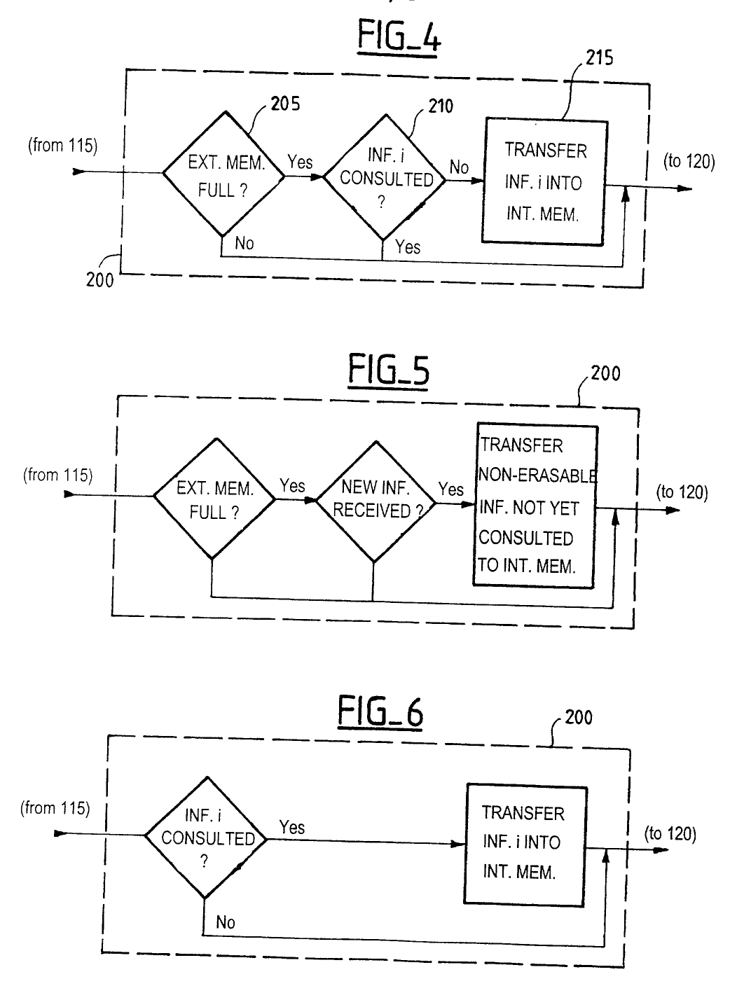

If it is not erasable, then the next step is the step 120 in which the value of the counter i is analyzed. The optional step 200 of processing non-erasable information can be executed before the step 120. Particular embodiments of the optional step 200 are described later with reference to FIGS. 4 to 6. From the step 120:

If i=N, then the next step is the time-delay step 105.

If i<N, then the counter i is incremented by one unit and the step 115 is executed again, to process the next item of information stored in the external memory.

Whether the information i has been consulted is determined in the step 130. The term “consulting” refers to reading if the information is an SMS message, to listening if the information is an audio file, or to viewing if the information is a video file. After the step 130:

If the information i has been consulted then the next step is the step 135 in which the information is erased. The next step after that is the step 120.

If the information has not been consulted, then the next step is the step 120.

This optimizes the memory without intervention by the user of the terminal. Information marked “erasable”, i.e. deemed by the sender not to need to be retained after it has been consulted, is automatically erased after it has been consulted by the user of the terminal that receives it.

Although the optimization method described with reference to FIG. 3 relates to an external memory, it is clear that the method applies equally to optimizing an internal memory of a radiocommunications terminal.

Moreover, another advantage of the invention is that the data representative of the erasable nature of the information is contained in one of the free bits of the DSC byte, and the DSC byte is already associated with the information in the prior art.

FIG. 4 shows a first embodiment of the optional step 200 for managing non-erasable information.

The step 200 is executed after the step 115 of FIG. 3, in which it was determined that the information i was not erasable.

Whether the external memory is full or not is determined in the first step 205:

If the external memory is not full, then the next step is the step 120 (FIG. 3), i.e. the stored information i is not modified,

If the external memory is full, then whether the information i has been consulted is determined during the step 210:

If it has been consulted, then the next step is the step 120 (FIG. 3),

Otherwise, the information i is transferred into the internal memory of the terminal in the step 215, the step after which is the step 120.

In the foregoing and subsequent description, the expression “transferring into a second memory” refers to freeing space in a first memory and storing the information extracted from the first memory in the second memory.

The method shown in FIG. 4 therefore guarantees free space in the external memory if it contains at least one non-erasable item of information that has not been consulted.

FIG. 5 shows a second embodiment of the optional step 200 for managing non-erasable information.

Whether the external memory is full or not is determined in the first step 220:

If the external memory is not full, then the next step is the step 120 (FIG. 3), as in the FIG. 4 embodiment,

If the external memory is full, then the next step is the step 225, in which it is determined it new information has just been received:

If no new information has been received, then the next step is the step 120,

Otherwise, the new non-erasable information that has not been consulted is transferred into the internal memory of the terminal during the step 230, the step after which is the step 120.

In the FIG. 5 embodiment, a space in the external memory is freed if, when new information is received, it contains a non-erasable item of information that has not been consulted and the external memory is full.

FIG. 6 shows a third embodiment of the optional step 200 for managing non-erasable information.

In the FIG. 6 embodiment, any non-erasable item of information that has been consulted is automatically transferred into the internal memory, so freeing the maximum space in the external memory.

1. A method of optimizing an external and/or internal memory of a radiocommunications terminal in which information received by said terminal is stored and permanently associated with an indicator representative of the erasable nature of said information, wherein erasable information is erased automatically as a function of the consulting of said information by the user.

2. A method according to claim 1, wherein the information is SMS information.

3. A method according to claim 1, wherein, if the information is sent by a user of another terminal, the step of permanently associating a status indicator representative of said information is executed by said user to force the automatic erasing of the information stored in the memory of the receiving terminal after it has been consulted by the user of the receiving terminal.

4. A method according to claim 1, wherein, if the information is sent by an operator of a radiocommunications network, the step of permanently associating a status indicator representative of said information is executed by the operator to force the automatic erasing of the information stored in the memory of the terminal after it has been consulted by the user of the terminal.

5. A method according to claim 1 wherein, when the information is transmitted, it is associated with a DCS multiplet including several bits, and wherein the indicator takes the form of one or more bits of said DCS multiplet.

6. A method according to claim 5, wherein the information received is associated with data representative of its consultation status.

7. A method according to claim 6, wherein said data is part of the DCS multiplet.

8. A method according to claim 1, wherein consulting entails the user reading the information.

9. A method according to claim 1, wherein, the radiocommunications terminal including an internal memory and an external memory, if the external memory is full, one or more non-erasable items of information that have not been consulted are transferred automatically into the internal memory.

10. A method according to claim 1, wherein, the radiocommunications terminal including an internal memory and an external memory, if information is received when the external memory is full, one or more non-erasable items of information that have not been consulted are transferred automatically into the internal memory.

11. A method according to claim 1, wherein, the radiocommunications terminal including an internal memory and an external memory, all non-erasable information is automatically transferred into the internal memory after it has been consulted.

12. A radiocommunications terminal for implementing the method according to claim 1, including an external and/or internal memory, the terminal including means for identifying an indicator of the erasable nature of information and means for automatically deleting erasable information received and stored in the memory of the terminal as a function of the consulting of said information by the user of the terminal.

13. A radiocommunications terminal according to claim 12, wherein the external memory is in a SIM card.

14. A radiocommunications terminal according to claim 12, including means for automatically transferring non-erasable information into the internal memory if the external memory is full.

15. A radiocommunications terminal according to claim 12, including means for automatically transferring non-erasable information that has not been consulted into the internal memory if information is received when the external memory is full.

16. A radiocommunications terminal according to claim 12, including means for automatically transferring non-erasable information into the internal memory after it has been consulted.
